(19) United States
(12) Patent Application Publication
(10) Pub. No.: US 2008/0266905 A1
(43) Pub. Date: Oct. 30, 2008

(54) Wire-guiding structure for a LED backlight module

(76) Inventor: Jiun-Yi Yeh, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/790,477

(22) Filed: Apr. 25, 2007

(51) Int. Cl. F21V 7/04

(52) U.S. Cl. 362/630

(57) ABSTRACT

A wire-guiding structure for a Light Emitting Diode (LED) backlight module comprises a case with at least an aperture for locating a backlight module with at least a LED light source therein. The aperture is provided for guiding the wire from the LED light source going out of the case.

### BACKGROUND OF THE INVENTION

1. Field of the Invention

The present invention relates to a wire-guiding structure for a LED backlight module and, more particularly, to an improved wire-guiding structure which provides at least an aperture on a case locating the backlight module therein so that the wire of a LED light source is able to go out of the case via that aperture.

2. Description of the Prior Art

With the dramatic development of the Internet and the wireless communication technology, information becomes easily accessible to everyone and thereby the personal information-related electronic products, such as notebooks, mobile phones, digital cameras, and personal digital assistants, are rapidly developed and grown. Going with the ascending tendency of the market on the Internet digital information, Liquid Crystal Display (LCD) is grown even faster and becomes thinner, lighter, less power consumption, safer and able to be incorporated in the semiconductor manufacturing technology. However, a LCD needs extra light source for emitting light. Conventionally, a reflective LCD is backed with a layer of reflective material that is provided under the LCD panel and reflects the ambient light back to the LCD panel to increase the brightness of the LCD panel. But this light source is unable to provide enough light solely by reflecting the ambient light in dark places. Thus, the need of extra light source for brightening the LCD panel is increasing and, in present days, backlight module becomes one critical part of a LCD.

A backlight module generally comprises a light source, a reflector, a guiding plate, and a pile of optical sheets. According to the position of the light source, backlight modules are classified into two groups: direct-type backlight modules and edge-mounted backlight modules. Generally, the source light includes cold cathode fluorescent lamp (CCFL), hot cathode fluorescent lamp, electroluminescent light source, and light emitting diode (LED), and the CCFL is used most wildly. However, the LED is advantageous that it is high color, high brightness, Mercury free, and high color saturation. Compared with the CCFL as the light source of a backlight module used in a LCD, the LED can provide more additional values and best vision for users. Thereby, it is a tendency that more and more cold cathode fluorescent lamps are replaced by the LEDs as the light source used in backlight.

FIG. 6 shows the general structure of an edge-mounted backlight module conventionally used in a LCD. As shown in FIG. 6, an edge-mounted backlight module is disposed under a LCD panel D with a frame D1 and comprises a LED light source A1, a reflector B1, a light guiding plate B2, and a pile of optical sheets B3. The backlight module is disposed within a case C. The LED light source A1 includes a LED bar A11 and a plurality of LEDs A12 disposed thereon, wherein the LED bar A11 can be a metal plate, a printed circuit board, or a soft plate. The pile of optical sheets B3 further includes a first diffuser B31, a first bright enhancement sheet B32, a second bright enhancement sheet B33, and a second diffuser B34. The case C further includes a bottom case C1 and lateral walls C2. When the LEDs A12 of the LED light source A1 are driven, uniform and highly bright light can be provided and the generated light will be guided toward the LCD panel D via the light guiding plate B2 to increase the brightness and the Luminance uniformity of the LCD panel D. The reflector B1 is disposed beneath the light guiding plate B2 used for reflecting back the light from the LED light source A1 into the light guiding plate B2 to prevent light leakage and enhance the light using efficiency. The diffusers B31, B34 are used for providing the LCD panel D uniform plane light source by optical diffusion effect of refraction, reflection, or scattering phenomenons generated when the light is passing through the diffusers B31, B34. However, the light passing through the diffusers B31 has low directivity. Thus, the light enhancement sheets B32, B33 are used for adjusting the light direction and focusing the light to elevate the brightness via light refraction and reflection.

Each LED light source A1 has lead wire A13 composed of several parallel thin guiding lines used for connecting the LED light source A1 with a drive circuit board (not shown in the figure). As shown in FIG. 6, the lead wire A13 goes out via an aperture C3 provided on one lateral wall C2 of the case C.

It needs only two lead wires for connecting the CCFL with the voltage converter in a LCD using CCFL as its light source. However, in large-size and high-brightness application of LED, the number of the pin-points are dramatically increasing with the using number of LED and a usual connector is difficult to be used due to the limited breadth of the LED bar. The reliability and the production capacity will be decreased if the technique of spot welding on a surface is adopted. Besides, the lead wire going out through the aperture on one lateral wall of the case would be easily disconnected from the LED bar by accidental pull and drag to result in the failure of the backlight module.

In order to improve the above-stated disadvantages to provide a wire-guiding structure for the lead wire from the LED bar securely going out, the inventor had the motive to try and develop the present invention after hard research.

### SUMMARY OF THE INVENTION

The primary object of the present invention is to provide a wire-guiding structure used in a LED backlight module for securely guiding a wire from a LED light source out of a case locating the backlight module therein to prevent the shortcoming of possible disconnection between the wire and the LED bar resulting from accidental pull and drag of the wire which goes out of the case via the aperture on one lateral wall of the case conventionally.

In order to achieve above object, the present invention provides a wire-guiding structure for a LED backlight module comprising a case locating the backlight module with at least a LED light source therein, and the case has at least one aperture thereon for the wire of the LED light source going out of the case.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is an exploded perspective view of a first embodiment of a wire-guiding structure according to the present invention.

FIG. 2 is a perspective view of the first embodiment.

FIG. 3 is a perspective view of a second embodiment of a wire-guiding structure according to the present invention.

FIG. 4 is a perspective view of a third embodiment of a wire-guiding structure according to the present invention.

FIG. 5 is a sectional view along the aa′ line in the FIG. 4.

FIG. 6 is an exploded perspective view of a conventional LED backlight module.

### DETAILED DESCRIPTION OF THE PREFERRED EMBODIMENTS

The present invention provides a wire-guiding structure for a LED backlight module comprising a case 2 for locating the backlight module with at least a LED light source 11 therein, and the case 2 has at least one aperture 23 thereon for the wire 113 of the LED light source 11 going out of the case 2.

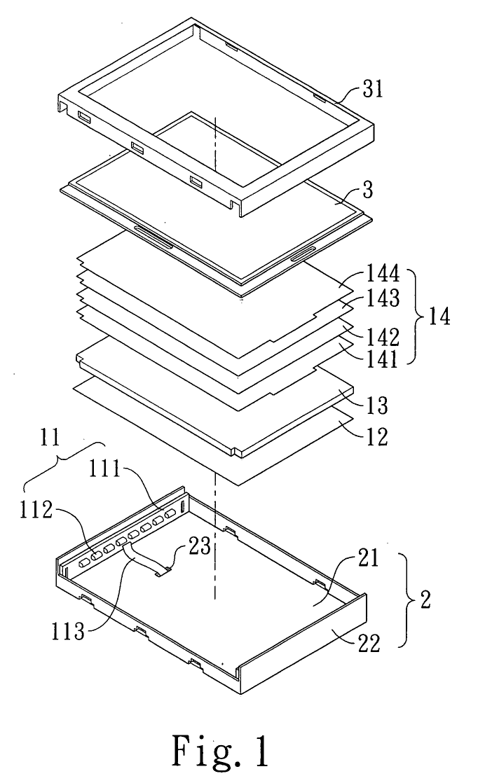

FIG. 1 shows an exploded perspective view of a first embodiment of a wire-guiding structure according to the present invention, wherein the backlight module is an edge-mounted backlight module. As shown in FIG. 1, the edge-mounted backlight module is placed under a LCD panel 3 with a frame 31 and comprises a LED light source 11, a reflector 12, a light guiding plate 13, and a pile of optical sheets 14. The backlight module is disposed within a case 2. The LED light source 11 includes a LED bar 111 and a plurality of LEDs 112 disposed thereon, wherein the LED bar 111 can be a metal plate, a printed circuit board, or a soft plate. The pile of optical sheets 14 further includes a first diffuser 141, a first bright enhancement sheet 142, a second bright enhancement sheet 143, and a second diffuser 144. The case 2 further includes a bottom 21 and lateral walls 22. When the LEDs 112 of the LED light source 11 are driven, uniform and highly bright light can be provided and the generated light will be guided toward the LCD panel 3 via the light guiding plate 13 to increase the brightness and the Luminance uniformity of the LCD panel 3. The reflector 12 is disposed beneath the light guiding plate 13 used for reflecting back the light from the LED light source 11 into the light guiding plate 13 to prevent light leakage and enhance the light using efficiency.

The LED light source 11 has a wire 113 for connecting the LED light source 11 with a driving circuit board (not shown in figures). The wire 113 goes out of the case 2 via the aperture 23 on the bottom 21 of the case 2 instead of going out via the aperture on one lateral wall conventionally. In this embodiment, the wire 113 is a flexible printed cable or a flexible flat cable. The shortcoming of using large number of the pinpoints is solved by using the flexible printed cable or the flexible flat cable. Besides, the flexible printed cable or the flexible flat cable is also much more flexible than the conventional guiding wire composed of several parallel thin guiding lines and can cooperate well with the present invention.

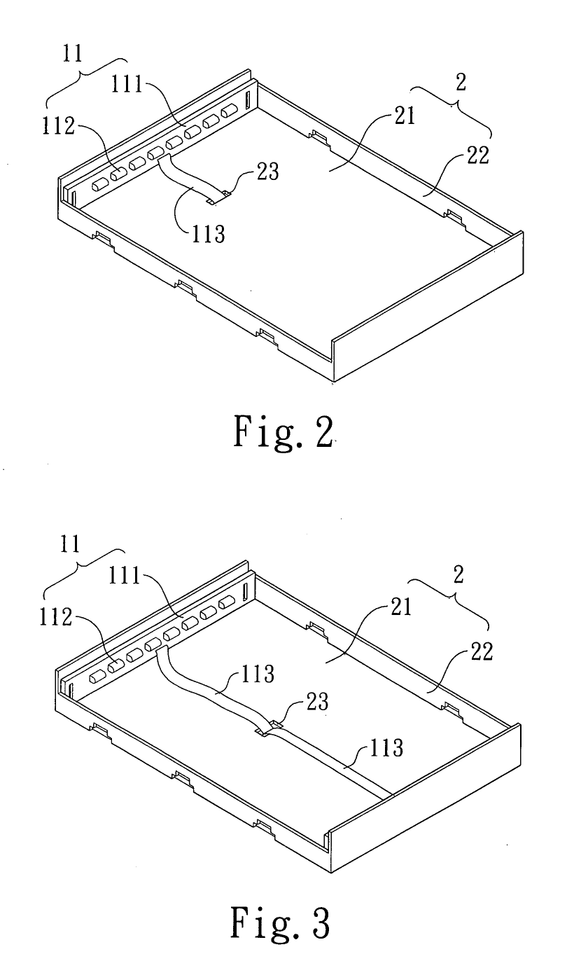

FIG. 2 shows a perspective view of the first embodiment. In order to make the features of the present invention clearer, in this figure shows only the LED light source 11 and the case 2. As shown in FIG. 2, the wire 113 coming from the LED bar 111 of the LED light source 11 turns 90 degrees to extend on the inner surface of the bottom 21 of the case 2 parallel to the reflector 12 (not shown in FIG. 2), and finally goes out of the case 2 via the aperture 23 provided on the bottom 21 of the case 2.

FIG. 3 shows a perspective view of a second embodiment. For the purpose of describing this embodiment conveniently, we will assign the same structure with the same number used in the first embodiment. Like the first embodiment, in FIG. 3 shows only the LED light source 11 and the case 2 and in this embodiment there are two LED light sources 11. As shown in FIG. 3, each LED light source 11 includes a LED bar 111 and a plurality of LEDs 112 and the case 2 includes a bottom 21 and lateral walls 22. Besides, on the bottom 21 of the case 2 is provided with one aperture 23 in this embodiment for the two wires 113 coming from the two LED light sources 11 to go out of the case 2. The two wires coming from the LED bars 111 of the LED light sources 11 turn 90 degrees to extend on the inner surface of the bottom 21 of the case 2 parallel to the reflector 12 (not shown in FIG. 3), and finally go out of the case 2 via the same aperture 23 on the bottom 21 of the case 2.

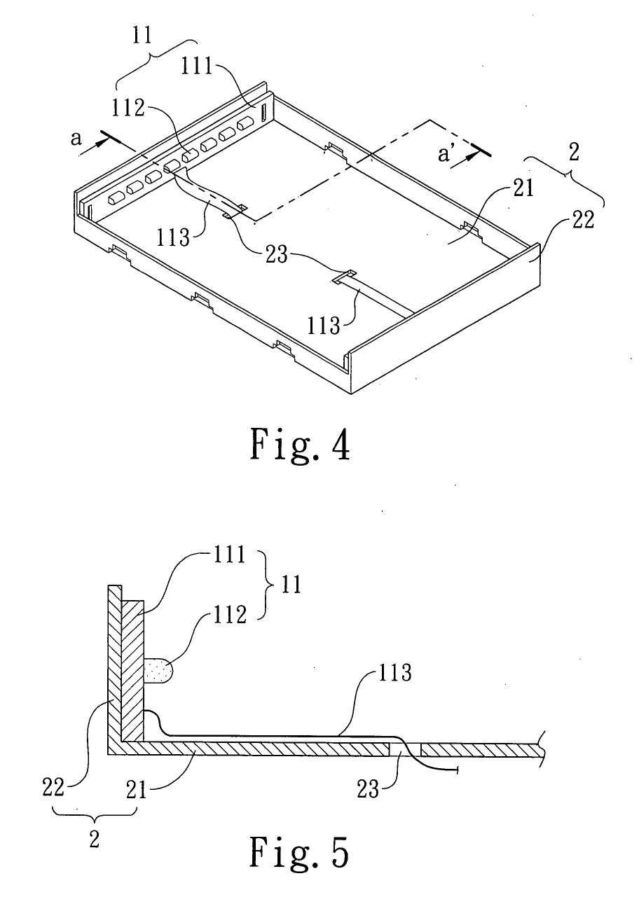

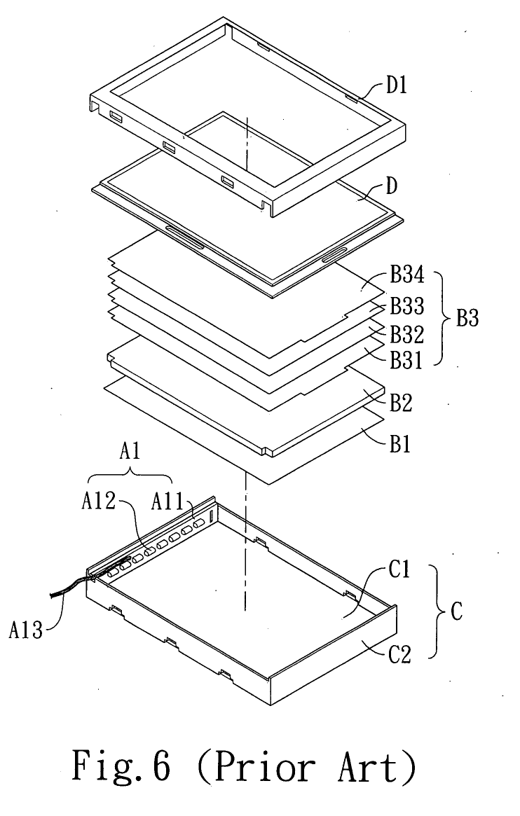

FIG. 4 shows a perspective view of a third embodiment. For the purpose of describing this embodiment conveniently, we will assign the same structure with the same number used in the first embodiment. In this figure also shows only the LED light source 11 and the case 2 and in this embodiment there are two LED light sources 11. Besides, as shown in FIG. 4, on the bottom 21 of the case 2 has two apertures 23 in this embodiment for the two wires 113 coming from the two LED light sources 11 to go out of the case 2 respectively. The two wires coming from the LED bars 111 of the LED light sources 11 turn 90 degrees to extend on the inner surface of the bottom 21 of the case 2 parallel to the reflector 12 (not shown in FIG. 3), and finally go out of the case 2 via different apertures 23 on the bottom 21 of the case 2. In order to make the present invention clearer, please refer to FIG. 5, which is a sectional view along the aa′ line in the FIG. 4. As shown in FIG. 5, the wire coming from the lower part of the LED bar 111 first turns 90 degrees, then extends parallel to the reflector 12 (not shown in FIG. 5), and finally goes out of the case 2 via the aperture 23.

Accordingly, the present invention has the following advantages:
1. The present invention can provide a wire-guiding structure for a LED backlight module, which can securely guide a wire from a LED light source out of a case and prevent the possible disconnection between the wire and the LED bar resulting from accidentally pulling and dragging the wire going out of the case via the aperture on the lateral wall of the case conventionally.
2. The present invention can provide a wire-guiding structure for a LED backlight module using a flexible printed cable or a flexible flat cable and the shortcoming of using large number of the pinpoints can be solved by using the flexible printed cable or the flexible flat cable. Besides, the flexible printed cable or the flexible flat cable is also much more flexible than the conventional guiding wire composed of several parallel thin guiding lines and can cooperate well with the present invention.

Accordingly, as disclosed in the above description and attached drawings, the present invention can provide a wire-guiding structure used in a LED backlight module for securely guiding a wire from a LED light source out of a case locating the backlight module therein to prevent the possible disconnection between the wire and the LED bar resulting from accidentally pulling and dragging the wire going out of the case via the conventional aperture on one lateral wall of the case. It is new and can be put into industrial use.

While the invention has been described with reference to certain embodiments, it will be understood by those skilled in the art that various changes may be made and equivalents may be substituted without departing from the scope of the present invention.

1. A wire-guiding structure for a LED backlight module, comprising a case locating the backlight module with at least one LED light source therein, wherein the case has at least one aperture on a bottom of the case for the wire of the LED light source to extend out of the case via the aperture.

2. The wire-guiding structure for a LED backlight module as claimed in claim 1, wherein the case is disposed with two LED light sources therein and has one aperture, and the wires from the two LED light sources go out of the case through the same aperture.

3. The wire-guiding structure for a LED backlight module as claimed in claim 2, wherein the wire is a flexible printed cable.

4. The wire-guiding structure for a LED backlight module as claimed in claim 2, wherein the wire is a flexible flat cable.

5. The wire-guiding structure for a LED backlight module as claimed in claim 1, wherein the case is disposed with two LED light sources therein and has two apertures, and the wires from the two LED light sources go out of the case through the apertures respectively.

6. The wire-guiding structure for a LED backlight module as claimed in claim 5, wherein the wire is a flexible printed cable.

7. The wire-guiding structure for a LED backlight module as claimed in claim 5, wherein the wire is a flexible flat cable.
